(19) United States
(12) Patent Application Publication
(10) Pub. No.: US 2007/0040743 A1
(43) Pub. Date: Feb. 22, 2007

(54) Method and arrangement for locating people

(76) Inventors: Peter Brettschneider, Geislingen (DE); Erich Puritscher, Weissach-Flacht (DE)

Correspondence Address: ROTHWELL, FIGG, ERNST & MANBECK, P.C., 1425 K STREET, N.W., SUITE 800, WASHINGTON, DC, 20005, US

(21) Appl. No.: 10/551,768

(22) PCT Filed: Apr. 2, 2004
(86) PCT No.: PCT/EP04/03509

§ 371 Date: Aug. 4, 2006

(30) Foreign Application Priority Data
Apr. 3, 2003 (DE) 103 15 277.6

(51) Int. Cl. G01S 3/02

(52) U.S. Cl. 342/463

(57) ABSTRACT

A method and an arrangement which locates people within a region which is to be monitored and can be used in a mobile manner. At least one transmitter working in an ultra-wide band (UWB) is used, in addition to at least one transmitter/receiver device working in the ultra-wide band (UWB) and a receiver working in the ultra-wide band (UWB). The transmitter is arranged in a fixed manner when used in region which is to be monitored, the transmitter/receiver device is disposed on a person who is to be located and the receiver is arranged on a monitoring computer arranged outside the region which is to be monitored and is connected thereto.

### CROSS-REFERENCE TO RELATED APPLICATION

This application is a National Phase of International Application Serial No. PCT/EP2004/003509, filed Apr. 2, 2004.

### BACKGROUND OF THE INVENTION

1. Field of the Invention

The invention relates to a method and an arrangement for locating persons within a monitored area, especially in terrain that is difficult to navigate or impassable as well as in enclosed structures above and below ground.

2. Description of the Background Art

In the fight against fires and similar dangerous situations assigned forces often have to advance into the affected area, such as a building, for fighting the fire and possibly recovering victims from the danger zone. During the fire-fighting efforts members of the assigned forces themselves may be at risk and require (additional) outside help, be it to navigate them out of the danger zone or assist them through the use of additional operational units.

A certain degree of relief is provided in this respect by mobile communications devices, which aid in the communication between the control center and assigned forces located on site in their operational efforts. Accurate positioning in the sense that the control center is continuously informed about the exact locations of the assigned forces in the disaster area however is still not possible with these devices.

EP 870 203 B1 disclosed already an arrangement for locating persons within an area that is to be monitored, comprising several base stations equipped with transmit/receive devices, respectively, of which at least one is located in the area to be monitored, and with a transmit/receive device being disposed on the person to be located. The base stations are influenced by the position relative to the mobile device. They are connected by wire or radio to a monitoring processor (control center) disposed outside the monitored area, and the processor evaluates the received signals.

In this known arrangement the transmit/receive device have to be installed in a stationary manner when used in the monitored area. The familiar arrangement is therefore disadvantageous in that corresponding devices used by the assigned forces arriving in case of a catastrophe have to be compatible with the installed devices.

### SUMMARY OF THE INVENTION

The invention is based on the object of providing a method and an arrangement for locating persons within a monitored area, which allow the locations of persons within the monitored area to be accurately determined and their paths across the monitored area to be tracked. The method and arrangement are intended to be used exclusively with the devices carried along by the arriving assigned forces.

This object is achieved according to the invention with a method used to locate the position of persons within a monitored area in a mobile application, in which at least one transmitter operating in the ultrawide band (UWB) spectrum, at least one transmit/receive device operating in the ultrawide band (UWB) spectrum and a receiver operating in the ultrawide band (UWB) spectrum are used, the transmitter being arranged stationary in the monitored area during the operation, the transmit/receive device being disposed on the person to be tracked, and the receiver being arranged on a monitoring processor (control center) located in an area outside the monitored area and being connected thereto.

The object is additionally achieved by a device used to locate the positions of people within a monitored area in a mobile application, comprising at least one transmitter operating in the ultrawide band (UWB) spectrum, at least one transmit/receive device operating in the ultrawide band (UWB) spectrum and a receiver operating in the ultrawide band (UWB) spectrum are used, the transmitter being arranged stationary in the monitored area during the application, the transmit/receive device being disposed on the person to be tracked, and the receiver being arranged on a monitoring processor (control center) located in an area outside the monitored area and being connected thereto.

Ultrawide band (UWB) technology can be used for telemetry if the distances are short, in outside terrain up to 200 m and in buildings up to 70, as a function of the design and the employed materials. The maximum distance is solely dependent on the strength of the pulses. The technology is based on approved U.S. regulations (FCC). Ultrawide band signals are extremely short pulses. They are emitted by mobile transmitters, the location of which is initially not known. These signals contain time information so that the distance of the individual devices can be calculated from the propagation time of the pulses. Each device therefore recognizes its neighboring devices in the network. The positioning accuracy achievable with ultrawide band is in the centimeter range. This way a network of the individual devices among each other is established, which still has no fixed reference point, but is in a position to determine the distances of the individual devices among each other with centimeter accuracy. It is possible to evaluate the ultrawide band signals both in buildings and outside terrain without restrictions. Obstacles that typically have a reflecting effect are penetrated. Moreover digital data can be transmitted using ultrawide band technology, and the data can then be evaluated in the appropriate facilities.

Yet, as explained above, the range of ultrawide band signals is limited. Ultrawide band technology is therefore preferably combined with the familiar LORAN-C positioning system. The LORAN-C system, which is available on a nearly worldwide basis, transmits long wave signals used for positioning purposes via stationary transmitter chains having known locations. More recently novel receiver systems comprising improved software and hardware specifically for signal processing have become available so that the requirements placed on the system here in terms of accuracy can be fulfilled. The use of special antennas has also contributed to significantly improving reception in interior spaces. By itself the LORAN-C system, however, would not offer sufficient reliability and accuracy.

In principle three devices suffice, namely the stationary transmitter to form the coordinates, the transceiver on the person to be tracked or monitored, and the receiver in the control center for data communication. These three devices form the basis of a variable coordinate system.

Accuracy and reliability of the method and the arrangement increase with the number of assigned forces located in the danger zone and the transceivers disposed on the respective personnel. The detection ability increases when a member of the assigned force leaves the plane defined by the stationary transmitter.

Preferably two stationary transmitters are provided in the monitored area to increase the levels of accuracy and reliability further.

With a transmitter disposed outside the plane defined by a first stationary transmitter the accuracy and reliability in the space can be improved further, for example when assigned forces operate in various planes of a monitored area.

If the monitored area is the inside of a building, it is recommended to install the stationary transmitter or transmitters in prominent locations on the building that are easily accessible from the outside, preferably on one or more vertical edges of the same.

Prerequisites for the function of the arrangement are a powerful portable processor (in the vehicle of the operational unit or on the outside) and a powerful program, which enables the following necessary and potentially desirable evaluations and illustrations.

The data should be illustrated as dots on the monitor of the processor, identifying the transceiver disposed on the member of assigned force, with the traveled path being depicted on the monitor. Desirable is also altitude information about the located person. Additionally queries about the time and the duration of the operation should be possible.

The corners of a polygon defined by the devices of the arrangement allow distances to be measured with centimeter accuracy.

The exchange of position data as well as the temporal synchronization between the mobile transceivers occur with each distance measurement in the comment section of a data log. Since each inquiry about distance measurements is received and responded to by each transceiver located in the reception area, this ensures that each transceiver has data about all surrounding units available.

When evaluating the data, the received signals are converted in vectors and depicted on the monitor.

Preferably corresponding digital building plans/land register plans of the respective operational locations should be available, which can then be depicted on the processor in the field. This primarily refers to plans such as the fire emergency plans in accordance with DIN 14095, but any other arbitrary layouts and city maps may be used as well. Satellite images of the operational terrain can also be depicted and evaluated on the processor in the field. This is above all required for activities in disaster areas to indicate how and where rescue units are or should be allocated and positioned.

If accurate digital building plans are available, the shortest passable path to a located person in the building can be calculated and illustrated on the plan. The operational unit supervisor has the possibility to mark no longer passable paths (routes, staircases etc.) in the available digital plan on the computer in the field. This is intended to be used to position the appropriate resources such as ladders as quickly as possible to enable an escape from the building.

The devices used in the system should preferably be configured identically as transmit/receive devices (transceivers), with the receiving part of the reference transmitter or transmitters and the transmitting part of the device installed at the control center, respectively, being switched off or inactive. It may however also be advantageous to equip the device disposed on the member of assigned force with sensors and corresponding signal transmitting devices, which allow information about the conditions at the location of the operation and the member of the assigned force to be captured and transmitted. This includes data about conditions such as the supply of oxygen (residual air), heart rate, temperature, duration of the operation etc., which are constantly updated by radio data transmission to support the operational unit supervisor in his decisions.

### BRIEF DESCRIPTION OF THE INVENTION

The invention will be explained in more detail based on the drawing, wherein:

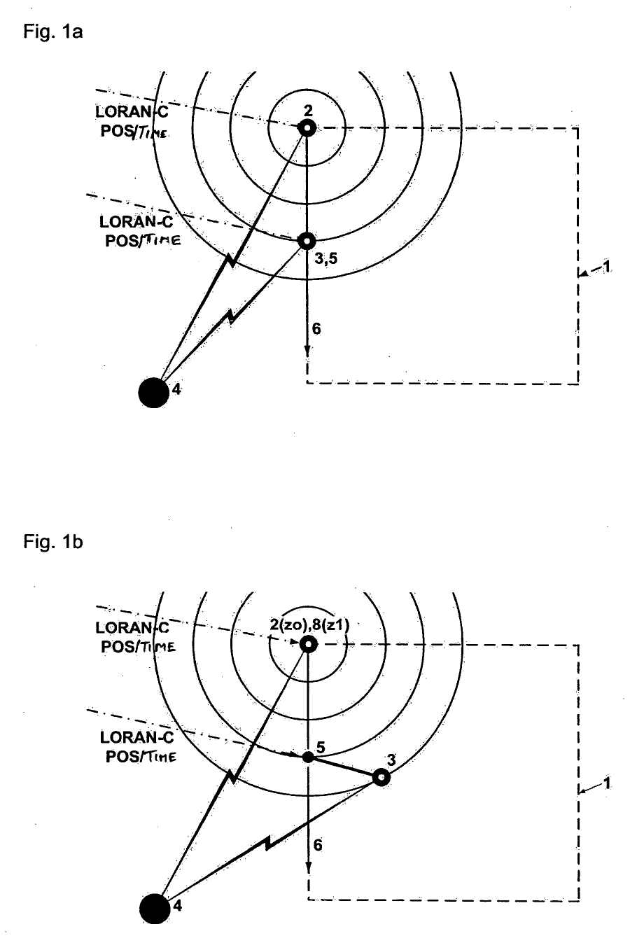

FIGS. 1a to 1d are diagrammatic illustrations of the process of the operation at the times T=t₀, t₁, t₂, or t₃,

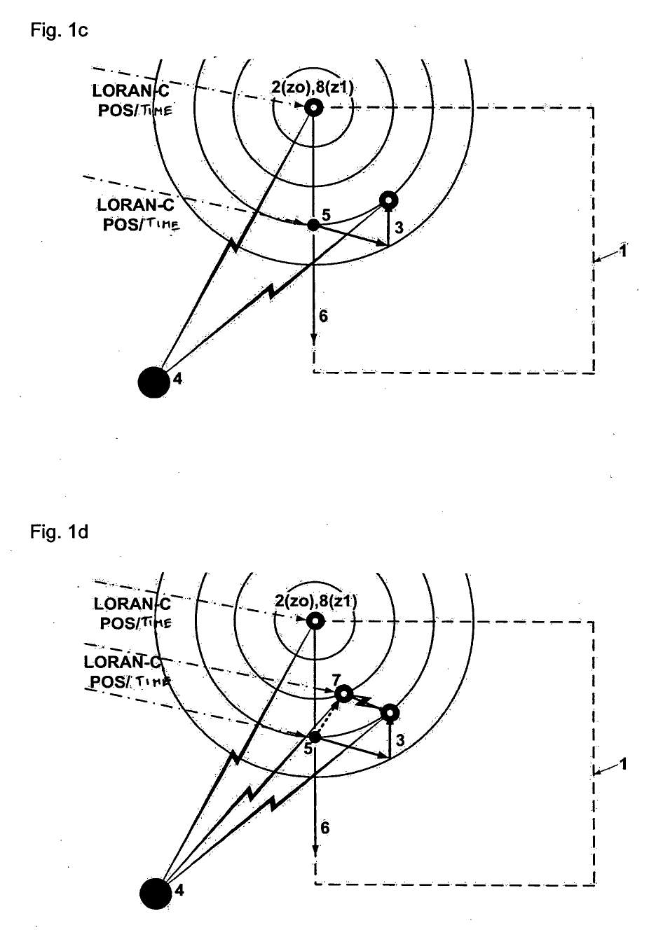

FIG. 2 is a diagrammatic illustration for the communication and propagation time measurement among the individual transmit/receive devices (transceivers), and

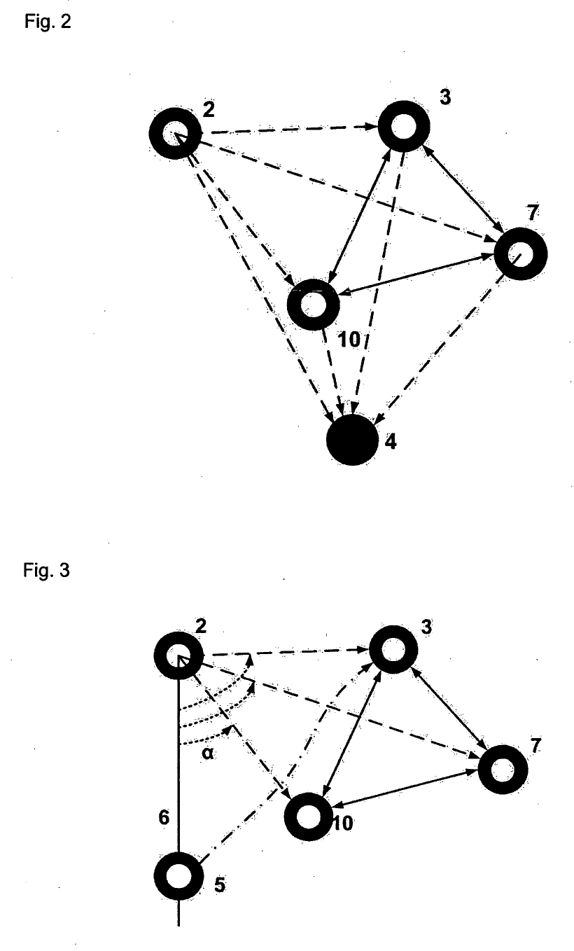

FIG. 3 is a diagrammatic illustration of the positioning process.

### DETAILED DESCRIPTION OF THE INVENTION

FIGS. 1a to 1d show the floor plan of a building 1 at an altitude z₀, on the corner of which a stationary transceiver 2 (referred to as “reference transceiver” hereinafter) was installed prior to the start of the operation. At the time T=t₀ (FIG. 1a) a member of the assigned force, to whom a mobile transceiver 3 (“mobile transceiver” hereinafter) has been attached, enters the building 1 through an opening (door, window, wall opening). Finally, a control center receiver 4, which is connected to an associated processor, is arranged in the mobile control center.

The transceivers 2, 3 have identical designs; they each comprise a LORAN-C element with the appropriate antenna and an ultrawide band element with an antenna and a receiver. The ultrawide band element is additionally equipped with a transmitter, at least in the devices that are disposed on the members of the force. Furthermore a power supply unit and a processor are provided. The mobile transceiver 3 may possibly additionally comprise a telemetric area for transmitting physical data and data from the surroundings of the force member. The transceivers themselves do not comprise any control elements. They are active as soon as they are taken out of the corresponding charging pod.

At the beginning of the operation, i.e. when the member of the assigned force enters the building 1 at the time T=t₀, a virtual reference point 5 and a reference line 6 are defined at this location, which extends away from the reference transceiver 2 preferably along a wall of the building 1. The virtual, computer-generated reference point 5 practically replaces another stationary reference transceiver (transmitter).

Upon entering the building 1, the member of the assigned force moves around and reaches the location illustrated in FIG. 1b at the time T=t₁, and the point shown in FIG. 1c at the time T=t₂.

During this time, the transceivers 2, 3 are connected to each other via the LORAN-C transmitter and the transceivers 2, 3, 4 via ultrawide band, with the mutual positions being tracked constantly by means of the available information. The operational unit supervisor can thus track the path of the unit member on the monitor of the processor at the control center and document it on the monitor (line from the reference point 5 to the two points shown in FIGS. 1b and 1c) so that the unit member can be located quickly even if the mobile transceiver 3 attached to the person should fail. In case of poor visibility (smoke development), the member of the assigned force (who of course wears sufficient respiratory protection equipment) can be directed via radio through the building 1. This is done in an especially safe and convenient manner when digitized land register plans are available and can be imported before the start of the operation.

After the first unit member the second one carrying a second mobile transceiver 7 has crossed the reference point 5 and the reference line 7. He reaches the spot indicated in FIG. 1d along the dotted line at the time T=t₃. As the second unit member enters, the mobile transceivers 3, 7 automatically establish a network among each other, thus increasing the accuracy and reliability of the system further. This network remains two-dimensional as long as the two and possible additional members move along the plane z₀. The network becomes automatically three-dimensional as soon as at least one member leaves the plane z₀, and the differences in altitude can be accurately measured, processed and depicted.

With respect to the measurement of altitudes the three-dimensional can be improved and simplified further when another reference transceiver 8 is installed on another plane z₁ of the building 1. The additional reference transceiver 8 can likewise be installed on a corner of the building 1 or in its immediate vicinity by means of a mast or turntable ladder. As soon as one unit member is located on the additionally defined plane z₁, it simplifies the required accuracy of the information of the 1st or 2nd plane z₀ or z₁.

FIG. 2 shows diagrammatically the communication between three mobile stations 3, 7 and 10. The reference transceiver 2 transmits to the mobile transceivers 2, 7 and 10, all transceivers transmit to the control station receiver 4, and the mobile transceivers 2, 7, 10 transmit and receive among each other (see the simple arrows and double arrows between the transceivers). The communication between the mobile transceivers 2, 7, 10 is configured as a peer-to-peer connection, i.e. the stations are equal to each other and have identical data transmission possibilities. This way every station may collect all data from all receivable stations and pass this data on again. This is advantageous when one station has no connection to the control center (e.g. due to shadowing effects).

FIG. 3 illustrates diagrammatically the positioning process in the plane. Initially the position of the stationary reference transceiver 2 is established using the LORAN-C system. Then the virtual reference point 5 and the reference line 6 are established at the location of the first unit member at the time the operation starts, specifically by measuring the LORAN-C position and propagation time (ultrawide band). During the operation, the propagation times between the mobile transceivers 3, 7, 10 as well as the propagation times and angles α between the reference transceiver 2 and mobile transceivers 2, 7, 10 are measured.

Two-dimensional positioning occurs by means of triangulation using the UWB data as well as by means of coupling the respective LORAN-C positions.

In order to measure the altitude another reference point has to be determined. If no high requirements are placed on the accuracy of the altitude measurements, it may suffice if the properties of the mobile network are used and the individual mobile transceivers are established as the reference points. To measure the relative altitude of a mobile transceiver (in relation to the input plane), a height reference point has to be established. This may be performed by positioning a second reference station on the outside wall of the building or positioning it on a mast or turntable ladder. The base line of both stations can then be used as a reference line.

1. A method for locating a person within a monitored area in a mobile application, in which at least one transmitter operating in an ultrawide band (UWB) spectrum, at least one transmit/receive device operating in the ultrawide band (UWB) spectrum, and a receiver operating in the ultrawide band (UWB) spectrum are used, the transmitter being arranged stationary in the monitored area during the operation, the transmit/receive device being disposed on the person to be located and the receiver being arranged on a monitoring processor located outside the monitored area and connected thereto, the transmitter and the transmit/receive device additionally operating based on a LORAN-C positioning system and position data determined by the LORAN-C system being combined using ultrawide band technology and corrected.

2. A method according to claim 1, characterized in that at least one other stationary transmitter is provided in the monitored area.

3. A method according to claim 2, characterized in that the additional transmitter is arranged outside the plane defined by the first stationary transmitter.

4. A method according to claim 1, characterized in that the monitored area is an inside of a building and the stationary transmitter is or are installed in a prominent location of the building that are is easily accessible.

5. An arrangement for locating persons within a monitored area in a mobile application, comprising at least one transmitter operating in an ultrawide band (UWB) spectrum, at least one transmit/receive device operating in the ultrawide band (UWB) spectrum, and a receiver operating in the ultrawide band (UWB) spectrum, the transmitter being arranged stationary in the monitored area during the operation, the transmit/receive device being disposed on a person to be located and the receiver being arranged on a monitoring processor located outside the monitored area and connected thereto, the transmitter and the transmit/receive device additionally operating based on a LORAN-C positioning system and the position data determined by the LORAN-C system being combined using ultrawide band technology and corrected.

6. An arrangement according to claim 5, characterized in that at least one other stationary transmitter is provided in the monitored area.

7. An arrangement according to claim 6, characterized in that the additional transmitter is arranged outside the plane defined by the first stationary transmitter.

8. An arrangement according to claim 5, characterized in that the monitored area is the inside of a building and the stationary transmitter is installed in a prominent location of the building that is easily accessible.

9. The method of claim 2 wherein the monitored area is an inside of a building and said at least one transmitter and said at least one other stationary transmitter are installed in prominent locations of the building that are easily accessible.

10. The method of claim 3 wherein the monitored area is an inside of a building and said at least one transmitter and said at least one other stationary transmitter are installed in prominent locations of the building that are easily accessible.

11. An arrangement of claim 6 wherein the monitored area is an inside of a building and said at least one transmitter and said at least one other stationary transmitter are installed in prominent locations of the building that are easily accessible.

12. An arrangement of claim 7 wherein the monitored area is an inside of a building and said at least one transmitter and said at least one other stationary transmitter are installed in prominent locations of the building that are easily accessible.
